(19) United States
(12) Patent Application Publication
(10) Pub. No.: US 2025/0252232 A1
(43) Pub. Date: Aug. 7, 2025

(54) Methods and Systems for a Reduced Physics Framework in Petroleum Reservoirs Forecasting

(71) Applicant: Xecta Intelligent Production Services, Houston, TX (US)

(72) Inventors: Zhenyu Guo, Houston, TX (US); Sathish Sankaran, Spring, TX (US)

(21) Appl. No.: 18/765,052

(22) Filed: Jul. 5, 2024

Related U.S. Application Data
(60) Provisional application No. 63/550,841, filed on Feb. 7, 2024.

(51) Int. Cl. G06F 30/28

(52) U.S. Cl. CPC G06F 30/27; G06F 2113/08

(57) ABSTRACT

A method of modeling fluid flow dynamics in a reservoir system, includes receiving observed data for the reservoir system; generating a plurality of model parameters in an initial fluid system model for the reservoir system; performing a plurality of reservoir simulations to determine a well response for the plurality of model parameters; generating a target response using the updated fluid system model for a forecast period; generating a machine learning (ML) model to correct a discrepancy between the target response and the observed data for the forecast period; and determining, using the ML model, a corrected target response for the forecast period.

### CROSS-REFERENCE TO RELATED APPLICATION

This application claims priority to U.S. Provisional Application No. 63/550,841 filed Feb. 7, 2024, entitled “METHODS AND SYSTEMS FOR A REDUCED PHYSICS FRAMEWORK IN PETROLEUM RESERVOIRS FORECASTING” by Zhenyu Guo and Sathish Sankaran, which is incorporated herein by reference as if reproduced in its entirety.

### TECHNICAL FIELD

This disclosure relates to reservoir characterization and future forecasting of subterranean petroleum reservoirs and, more particularly, to methods for modeling fluid flow dynamics in a reservoir system using a machine learning (ML)-enhanced history-matching algorithm.

### BACKGROUND

Developing unconventional and conventional reservoirs has triggered a reimagination of reservoir engineering models and methodologies. Completing horizontal wells with multi-stage fracturing has enabled the commercial production of hydrocarbon resources in ultra-low permeability rock. It is essential to accurately model fluid flow dynamics in a petroleum reservoir system with a plurality of wells. In particular, the plurality of wells may be connected. A three-dimensional (3D) reservoir model is beneficial in properly understanding well performance across the whole life of the plurality of wells for field development planning and production optimization for maximum economic value. Closed loop reservoir management (CLRM) may be implemented to generate a 3D numerical simulation model to describe the 3D reservoir model associated with the petroleum reservoir system. However, CLRM is challenged with building reliable and fast predictive reservoir models to make field decisions. It may be computationally prohibitive for a complicated reservoir system to create the 3D reservoir model of a channelized oil reservoir for short-term decision cycles in field applications. In particular, the 3D reservoir model may be challenging to characterize, tedious to build and calibrate, and sometimes computationally prohibitive for short-term decision cycles in field applications. On the other hand, pure data-driven methods often need more physical insights and have limited applicability. There is a need for a modeling method and system that is easy to build, history match, compute, and interpret.

History matching and production optimization are two crucial components in CLRM. In practice, these two components typically require a commercial simulator for flow simulation. For example, history matching and production optimization require a plurality of forward-model evaluations to make high-quality decisions promptly. In particular, for the conventional forward modeling approach, a full-physics 3D reservoir simulation model is often intractable in handling CLRM due to expensive computational costs, the long model-building process, and often insufficient data inputs. As another example, some existing fluid modeling techniques calculate the parameters of the fluid system explicitly based on the properties of the fluid system model. This often requires other models to be calculated, such as geological models and the solution of complex equations, which may require commercial simulators. Though computational power has increased significantly over the past few decades, the complexity and resolution of practical fluid models have also increased accordingly. Hydrocarbon reservoir flow simulation is often based on a full 3D geo-cellular model and can take hours or days for large-scale field cases, which makes efficient history matching and reservoir management exercises challenging, as many simulation runs are needed. As a result, researchers have been focusing on developing techniques that can mitigate the drawbacks of full-scale simulation models.

Reservoir graph network (RGNet) may apply a reduced-physics approach for reservoir management problems, spanning reservoir connectivity analysis, resource volume estimation, forecasting, and flood optimization. RGNet is developed based on the concept of diffusive time of flight (DTOF). In particular, RGNet parameterizes a 3D reservoir by a set of one-dimensional (1D) grid blocks with interconnecting wells, which enables fast model runs by reducing the system complexity. The set-up of an RGNet model does not need interpretive forward modeling with geological and geo-mechanical characterization of the reservoir. Instead, the model parameters of RGNet may be decided by history-matching the observed data from the field. The parameters considered in RGNet include, but are not limited to relative permeabilities, initial saturations, well indices, cell pore volumes, and transmissibilities. RGNet presents a general framework where any fluid and rock physics can be incorporated.). Therefore, RGNet may determine a reservoir model that captures essential features of flow in a petroleum reservoir system while simplifying complexities.

Existing techniques to improve reservoir simulation efficiency can speed up the simulation at various degrees; however, they generally start with a 3D geo-cellular model that may be difficult to build for complex systems. In addition, some of these methods are intrusive to the simulator, which is challenging to implement with a commercial simulator. Other models have drawbacks due to the limited physics that can be incorporated and the simplifying assumptions that are required. Yet other models require constructing connections between well/connection pairs determined based on the Euclidean distance. In cases when strong heterogeneity or high permeability channels exist, such treatment may be problematic.

### BRIEF DESCRIPTION OF THE DRAWINGS

These drawings illustrate certain aspects of some of the embodiments of the present disclosure and should not be used to limit or define the claims.

FIG. 1A illustrates an example top view of pressure contour for a 3D reservoir system with one well, in accordance with certain embodiments.

FIG. 1B illustrates an example 1D RGNet grid for a 1D system for the 3D reservoir system in FIG. 1A, in accordance with certain embodiments.

FIG. 2 illustrates an example simulation grid for a two-well RGNet model, in accordance with certain embodiments.

FIG. 3 illustrates an example conversion of a target function from an original space to a feature space with a higher dimension, in accordance with certain embodiments.

FIG. 4 illustrates an example physics-informed machine-learning (PIML) architecture, in accordance with certain embodiments.

FIG. 5 illustrates an example method for performing an enhanced RGNet with PIML history matching with support-vector-regression using distributed-Gauss-Newton (SVR-DGN) for a reservoir system, in accordance with certain embodiments.

FIG. 6 illustrates a block diagram of an exemplary control unit, in accordance with certain embodiments.

FIG. 7A illustrates an example synthetic egg model of a permeability field, in accordance with certain embodiments.

FIG. 7B illustrates an example history matching result for a plurality of wells in FIG. 7A, in accordance with certain embodiments.

FIGS. 7C and 7D illustrate example distributions of data mismatch and number of inactive connections, respectively, for the reservoir model in FIG. 7A, in accordance with certain embodiments.

FIG. 8A illustrates an example full connection map for the reservoir model in FIG. 7A, in accordance with certain embodiments.

FIG. 8B illustrates an example single realization of sparsity-constrained well connections map for the reservoir model in FIG. 7A, in accordance with certain embodiments.

FIG. 9 illustrates an example connection map from operator knowledge for a real reservoir system, in accordance with certain embodiments.

FIGS. 10A-10F illustrate example history matching results for a plurality of wells associated with the real reservoir system in FIG. 9, in accordance with certain embodiments.

FIGS. 11A-E illustrate example forecast result for the plurality of wells associated with the real reservoir system in FIG. 9, in accordance with certain embodiments.

FIGS. 12A and 12B illustrate example cross plots of bottom-hole pressure (BHP) for corrected and uncorrected RGNet results during the training historical period for the real reservoir system in FIG. 9, in accordance with certain embodiments.

FIGS. 13A and 13B illustrate example cross plots of water rate for corrected and uncorrected RGNet results during the training historical period for the real reservoir system in FIG. 9, in accordance with certain embodiments.

FIGS. 14A and 14B illustrate example cross plots of BHP for corrected and uncorrected RGNet results during the testing (forecast) period for the real reservoir system in FIG. 9, in accordance with certain embodiments.

FIGS. 15A and 15B illustrate example cross plots of water rate for corrected and uncorrected RGNet results during the testing (forecast) period for the real reservoir system in FIG. 9, in accordance with certain embodiments.

While embodiments of this disclosure have been depicted and described and are defined by reference to exemplary embodiments of the disclosure, such references do not imply a limitation on the disclosure, and no such limitation is to be inferred. The subject matter disclosed is capable of considerable modification, alteration, and equivalents in form and function, as will occur to those skilled in the pertinent art and having the benefit of this disclosure. The depicted and described embodiments of this disclosure are examples only, and not exhaustive of the scope of the disclosure.

### DETAILED DESCRIPTION

Illustrative embodiments of the present disclosure are described in detail herein. In the interest of clarity, not all features of an actual implementation may be described in this specification. It will of course be appreciated that in the development of any such actual embodiment, numerous implementation-specific decisions may be made to achieve the specific implementation goals, which may vary from one implementation to another. Moreover, it will be appreciated that such a development effort might be complex and time-consuming but would nevertheless be a routine undertaking for those of ordinary skill in the art having the benefit of the present disclosure.

The present disclosure relates to methods and systems for modeling fluid flow dynamics in fluid systems. In some embodiments, the modeling may include a machine learning (ML) enhanced history-matching algorithm, and a physics-informed machine learning (PIML) algorithm, or both.

More specifically, the present disclosure provides methods, including a reduced physics framework using an RGNet model for forecasting in petroleum reservoirs. The reduced physics framework may be configured to improve the quality of the RGNet using a multi-response ML model to significantly reduce training costs for a plurality of proxy models which are used for history matching. The RGNet model may be determined by implementing a sparsity-constrained history-matching approach to simultaneously determine the well connection pattern, reservoir connectivity, and other related model parameters. The multi-response ML model may, in certain embodiments, be determined by implementing an improved version of support-vector-regression with distributed-Gauss-Newton (SVR-DGN), which is a hybrid approach that combines ML with Gauss-Newton trust-region (GN-TR) to find multiple best-matched realizations. In some embodiments, the RGNet model may be combined with a sparsity-constrained history matching model and a physics-informed ML model to improve the accuracy of the RGNet model for forecasting.

Understanding well production performance in petroleum reservoirs is useful for achieving optimal field development and maximizing value. It is desired to have a robust and scalable method for quantifying well productivity, which can be applied practically to all wells, overcoming the limitations of decline curve analysis (which may not be representative of changing operating conditions) and analytical and numerical models (which may be based on either simplifying assumptions or require manual interpretation or not suitable for large scale usage).

An example embodiment features a reduced physics model to use routinely measured data for most wells—namely, production rates, flowing pressure, and fluid properties. As a hybrid method, example embodiments are data-centric but rooted in physics-based principles and capture the dynamic evolution of the system by using an ML-enhanced history-matching algorithm to identify multiple best-matched realizations. In some embodiments, the ML-enhanced history-matching algorithm may include an SVR-DGN model, which is trained to learn the mapping from a plurality of model parameters to multiple well responses. For example, the ML-enhanced history-matching algorithm may implement RGNet with SVR-DGN to simultaneously match multiple types of observed data, such as bottom-hole pressure (BHP), gas-oil ratio (GOR), and water cut (WCT). As a result, the ML-enhanced history-matching algorithm may significantly reduce the computational cost required to estimate the sensitivity matrix for a gradient-based history-matching algorithm.

In some embodiments, the ML-enhanced history-matching algorithm may include a sparsity-constrained history-matching algorithm and/or a physics-informed machine learning (PIML) algorithm. The sparsity-constrained history-matching may accurately identify key inter-well connections while matching the data by considering uncertainty in well-connection patterns and providing multiple realizations for connecting wells. In reservoir dynamic modeling, RGNet may capture major features of a target reservoir while potentially overlooking minor details due to “reduced” physics. The integration of ML into RGNet may add more model details for small features, thereby improving model accuracy. Therefore, the ML-enhanced history-matching algorithm may obtain well connectivity in a minimum viable pattern and other model parameters while simultaneously matching the data and enhancing the forecasting accuracy of RGNet models by improving model fidelity without compromising a rapid computational speed.

### Reservoir Simulation Models

Oil companies and oil reservoir management consultants routinely use reservoir simulators in reservoir management. In particularly, a plurality of sensors are deployed at various locations of a target reservoir system to obtain one or more types of data at various time intervals. A reservoir simulator may use the one or more types of data to create a reservoir simulation and model. CLRM is a combination of model-based optimization and data assimilation based on computer-assisted history matching. CLRM may determine a dynamic and real-time optimal production schedule to maximize reservoir performance over the life of the target reservoir system by changing reservoir management from a periodic to a near-continuous process. For example, CLRM may be used to adjust one or more injection and production schemes under the existing reservoir conditions to exploit limited oil reserves more economically and efficiently. CLRM typically involves two key components: automatic history matching and reservoir production optimization. Both automatic history matching and reservoir production optimization require a plurality of forward-model evaluations to solve large-scale complicated optimization problems in a timely manner for high-quality decisions. In particular, conventional forward modeling methods use a full-physics 3D reservoir simulation model, which is often intractable when handling CLRM due to expensive computational costs, the long process of model building, and insufficient data inputs. As a result, researchers have been focusing on developing techniques that can mitigate the drawbacks of full-scale simulation models.

In some embodiments, traditional reservoir simulation methods, such as an upscaling method, a streamline modeling method, a fast-marching method, a reduced-order modeling method, and a multi-scale method, may be used to reduce the computational cost of a simulation model by significantly speeding up the process of reservoir simulation. However, the plurality of reservoir simulation methods still need a long process to build a detailed geological model. In addition, some of the plurality of reservoir simulation methods require access to the internals or great effort to optimize the source code of reservoir simulators for better performance.

In some embodiments, the traditional reservoir simulation methods may use a physics-based data-driven model to represent a geo-model-free approach for efficient evaluation of reservoir models. For example, a capacitance-resistance model (CRM) may be used for reservoir connectivity analysis and forecasting. CRM may be derived based on the material balance of single-phase fluid in the reservoir, and ad-hoc approaches are invented to deal with multi-phase forecasting. As another example, inter-well numerical simulation model (INSIM) is developed to explicitly model oil-water two-phase systems by solving Buckley-Leverett (B-L) equations. In particular, an improved INSIM based on front-tracking (INSIM-FT) may be implemented in a 3D petroleum reservoir system considering the effects of gravitational forces and more accurate modeling of BHP. In general, the traditional reservoir simulation models are specially designed to complete certain tasks and may not be good fits for general-purpose applications to handle all different types of reservoirs.

### Reduced Physics Models

In some embodiments, a reduced physics model, such as a flow network model, may be developed as a type of reservoir model with fit-for-purpose physics. The flow network model starts from the flow physics and develops a reduced model, which is used as a simplified inter-well numerical simulation model to match observed or simulated data. The flow network model may represent the targeted petroleum reservoir system as a flow network with a plurality of flow paths connecting injectors and producers. The fluid movement inside each flow path is calculated by solving a 1D system of flow equations. Compared to CRM and INSIM-like approaches, the reduced-physics model uses the same set of governing equations as regular full-scale models, with a much smaller number of grid blocks and less computational cost. In particular, a flow network model may be described by a set of one-dimensional (1D) grid blocks that connect wells and then solved using a finite-difference (FD) method. For example, a general-purpose network model (GPSNet) may be determined using a generalized framework by introducing the capability to integrate the workflow with a commercial simulator. In some embodiments, GPSNet may be used in a large-scale field with more than 1,000 wells. For example, GPSNet may use a conventional simulator as a data-driven network model which seeks to reproduce observed and predict future well responses. The data-driven network model is formulated on the topology of a coarse volumetric 3D grid. However, the GPS Network model does not include any interaction among the inter-well flow paths except through the well cells at each end.

In some embodiments, an RGNet model may increase possible flow paths by using inter-partition transmissibilities which turn the interconnection among the dynamic drainage volumes of individual wells into a general reservoir network. RGNet is derived based on the concept of DTOF that is used to convert a 3D reservoir flow problem to a 1D representation. Traditionally, DTOF can be obtained by solving the Eikonal equation for a 3D model using fast-marching techniques. RGNet may not need to start with a geo-model, and the model parameters are decided through history matching. In particular, The RGNet model may be improved by using distance-based gridding for concise and explainable connections and a more robust pressure-match algorithm. As a result, the RGNet model may be extended to handle multi-phase unconventional wells by adding relative permeability coefficients as parameters and plugging in the key physics of pressure-dependent permeability.

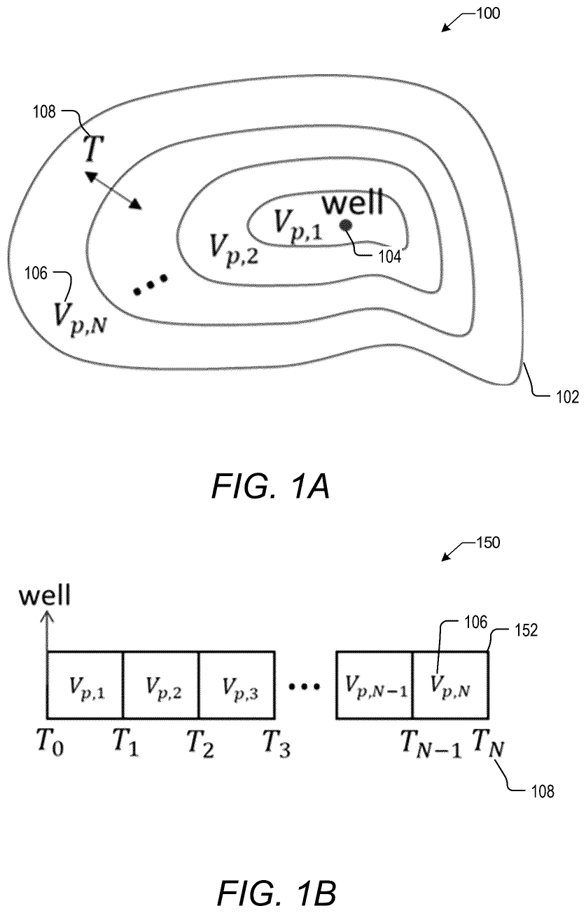

FIG. 1A illustrates an example top view of pressure contour for a 3D reservoir system 100 with one well, in accordance with certain embodiments. The 3D reservoir system 100 may include a plurality of contour rings 102 with a well 104 in the center. Each of the plurality of contour rings 102 may be associated with a pore-volume Vₚ 106 and a transmissibility T 108 across the corresponding contour ring to control the communication of neighboring volumes. For example, the i-th contour ring is associated with pore-volume V_{p,i}, and transmissibility Tᵢ.

FIG. 1B illustrates an example 1D RGNet grid for a 1D system 150 for the 3D reservoir system 100 in FIG. 1A, in accordance with certain embodiments. In particular, the 1D RGNet grids may use 1D modeling for the 1D system 150. Each grid represents a pore-volume Vₚ 106 between two neighboring contour rings and a transmissibility T 108 across a corresponding contour ring. Each grid interface 152 from left to right corresponds to each contour line from the inside out. The governing equation for the 1D system 150 in two phases is given by:

$$\frac{\partial }{\partial t} ( ϕ \frac{{S}_{j}}{{B}_{j}} ) = \frac{\partial }{\partial x} ( \frac{k {k}_{r , j}}{{B}_{j} {μ}_{j}} \frac{\partial p}{\partial x} ) + \frac{{\tilde{q}}_{j}}{{B}_{j}} δ ( {x}_{w} ) \qquad ( 1 )$$

In some embodiments, the discretized governing equation for the 1D system 150 in two phases is derived as:

$$\begin{matrix}\frac{1}{Δ t} {( {V}_{p , i} \frac{{S}_{j , i}}{{B}_{j , i}} )}^{n + 1} - \frac{1}{Δ t} {( {V}_{p , i} \frac{{S}_{j , i}}{{B}_{j , i}} )}^{n} \\ = {T}_{i + \frac{1}{2}} {{λ}_{j , i + \frac{1}{2}}^{n + 1} ( {p}_{i + 1} - {p}_{i} )}^{n + 1} + {T}_{i - \frac{1}{2}} {{λ}_{j , i - \frac{1}{2}}^{n + 1} ( {p}_{i - 1} - {p}_{i} )}^{n + 1} + \frac{{q}_{j} δ ( {x}_{w} )}{{B}_{j , i}^{n + 1}}\end{matrix} \qquad ( 2 )$$

$$T = \frac{kA}{Δ x} \qquad ( 3 )$$

$${λ}_{j} = \frac{{k}_{r , j}}{{B}_{j} {μ}_{j}} \qquad ( 4 )$$

$${V}_{p} = A Δ x ϕ \qquad ( 5 )$$

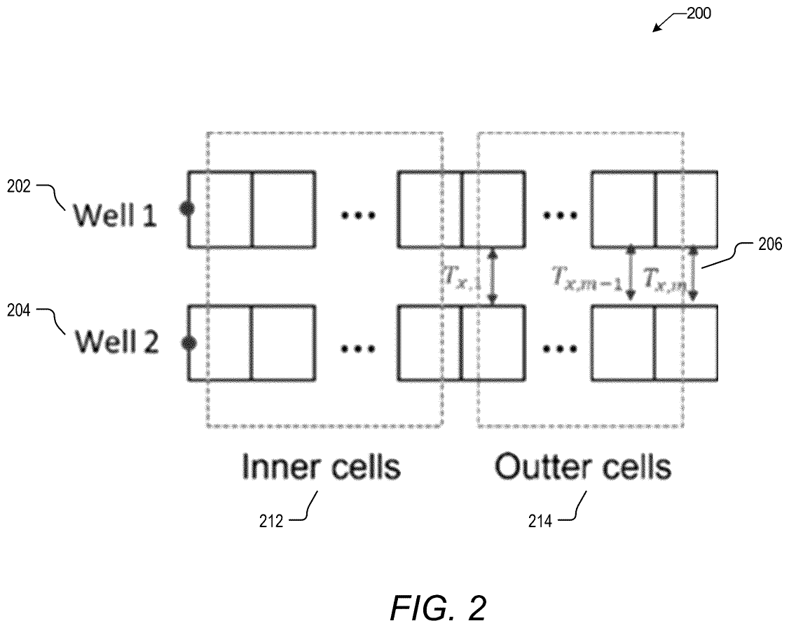

FIG. 2 illustrates an example simulation grid for a two-well RGNet model 200, in accordance with certain embodiments. The RGNet model 200 may be implemented to simulate the flow for a reservoir with two wells 202, 204. The RGNet model 200 may simulate pore-volume Vₚ and transmissibility T associated with each well for cells at inner regions 212 and outer regions 214. In particular, the RGNet model 200 may simulate an inter-well transmissibility Tₓ 206 for cells at outer regions 214 of the two wells to control well interference. By calibrating Vₚ, T, Tₓ, and other related parameters using historical data, a history-matched RGNet model may couple with the surface network.

The proposed workflow uses an ML-enhanced history-matching algorithm to enhance RGNet by integrating one or more machine-learning (ML) algorithms. At a high level, the ML-enhanced history-matching algorithm may be applied to identify multiple best-matched realizations. In some embodiments, the ML-enhanced history-matching algorithm may train an SVR-DGN model to learn the mapping from a plurality of model parameters to multiple well responses. Such a multi-response ML model may significantly reduce the training cost for proxy models that are used for history matching. In some embodiments, the ML-enhanced history-matching algorithm may use a sparsity-constrained history-matching approach to simultaneously determine the well connection pattern, reservoir connectivity, and other related model parameters. In some embodiments, the ML-enhanced history-matching algorithm may use a physics-informed ML model to improve the accuracy of RGNet models for forecasting.

History Matching with SVR-DGN

In some embodiments, history matching is an important step in an RGNet workflow. Different assisted history matching (AHM) algorithms may be used to minimize Equation 6 to obtain a history match. In particular, a commonly used objective function for history matching is defined as:

$$O ( x ) = \frac{1}{2} {( y ( x ) - {y}_{obs} )}^{T} {C}_{d}^{- 1} ( y ( x ) - {y}_{obs} ) \qquad ( 6 )$$

where x represents the vector of model parameters; y represents the vector of simulation response; y_{obs} represents the vector of observed data; and C_{d} is the covariance matrix of data measurement error.

In some embodiments, SVR-DGN is a hybrid approach which combines ML with the Gauss-Newton trust-region (GN-TR) to find multiple best-matched realizations. The basic idea of GN-TR is to minimize an approximate O(x) of Eq. 6 as given by:

$$Q ( x ) = O ( {x}_{0} ) + ∇ O ( {x}_{0} ) Δ x + \frac{1}{2} Δ {x}^{T} H ( {x}_{0} ) Δ x \qquad ( 7 )$$

$$Δ x = x - {x}_{0} \qquad ( 8 )$$

$$∇ O ( {x}_{0} = ∇ {y ( {x}_{0} )}^{T} {C}_{D}^{- 1} [ y ( {x}_{0} ) - {y}_{obs} ] \qquad ( 9 )$$

$$H ( {x}_{0} ) = ∇ {y ( {x}_{0} )}^{T} {{C}_{d}^{- 1} ( ∇ {y ( {x}_{0} )}^{T} )}^{T} \qquad ( 10 )$$

where x represents the vector of model parameters; y represents the vector of simulation response; y_{obs} represents the vector of observed data; and C_{d} is the covariance matrix of data measurement error; x₀ represents the starting point for optimization; ΔO(x₀) is the gradient of O(x); and H(x₀) is the Gauss-Newton Hession.

In some embodiments, minimizing Q(x) of Equation 7 is a much less complex task compared to directly minimizing O(x) of Equation 6 due to less non-linearity. However, as Q(x) is a good approximation for O(x) if x is close to x₀, we wish to find a solution which minimizes the objective function Q(x) for history matching such that the solution is within a trust-region radius from the starting point for optimization by satisfying Equations 11 and 12:

$$minimize Q ( x ) \qquad ( 11 )$$

$$‖ x - {x}_{0} ‖ < Δ \qquad ( 12 )$$

where Q(x) is the objective function for history matching; x represents the vector of model parameters; x₀ represents the starting point for optimization and Δ is the trust-region radius.

In some embodiments, the trust-region subproblem in Equations 11 and 12 aims to obtain an optimal solution x* in a ball-shaped region centered by x₀. Once x* is found, Q(x) is reconstructed by using x₀=x* and a new solution is obtained by solving Equations 11 and 12. The process is repeated until convergence. When the Gauss-Newton Hessian is used, the optimization method is called Gauss-Newton trust-region (GN-TR). (∇y(x₀)^{T})^{T} in Equation 10 is also referred to as the sensitivity matrix, which is often computationally expensive to calculate.

In some embodiments, history matching with SVR-DGN may use a least-square SVR (LS-SVR) as the proxy due to the relatively low training cost and the ease of obtaining the derivatives. In particular, history matching with SVR-DGN may train a plurality of proxy models with closed-form formulations to analytically analyze derivatives of the plurality of proxy models in order to reduce the computational cost for sensitivity-matrix calculation. The LS-SVR may map a target function from an input space into a higher-dimensional feature space where the features are linearly correlated to the output variable. In some embodiments, the training data for the proxy come from existing simulation runs, so no extra simulation runs are required. Once the proxy is obtained, history matching with SVR-DGN may differentiate the LS-SVR models directly to obtain the estimated sensitivity matrix. As a result, history matching with SVR-DGN may increase the efficiency of the entire history-matching workflow by a factor of 3 compared to traditional history matching methods without using SVR.

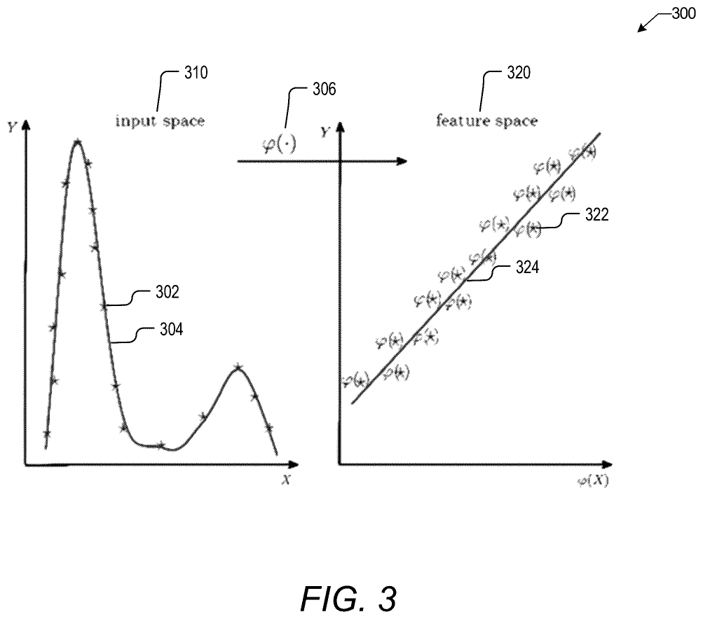

FIG. 3 illustrates an example conversion 300 of a target function from an original space to a feature space with a higher dimension in accordance with certain embodiments. The target function includes a plurality of features 302 which match a non-linear curve 304 in the input space 310. The LS-SVR may determine a mapping function (x) 306 to convert the plurality of features 302 in the input space 310 to a plurality of converted features 322 which matches a linear line 324 in the feature space 320 with a higher dimension. As a result, the converted features 322 are linearly correlated to the output variable y. By defining the mapping function by q (x), the proxy for a scalar output y is given by

$$\hat{y} ( x ) = {w}^{T} φ ( x ) + b \qquad ( 13 )$$

where ŷ is a scalar output from the proxy in the feature space; φ(x) is the input of the proxy in the feature space; w^{T} is the slope of the linear equation, and b is the ŷ intercept of the linear equation.

In some embodiments, the LS-SVR proxy may include a loss function based on a single scalar response variable by minimizing the data mismatch and the model complexity based on Equation 14. In particular, the LS-SVR loss function may be simplified in Equations 15 and 16.

$$minimize \frac{1}{2} {w}^{T} w + \frac{1}{2} γ {\sum }_{k = 1}^{{N}_{s}} {( {y}_{k} - {\hat{y}}_{k} )}^{2} = \frac{1}{2} {w}^{T} w + \frac{1}{2} γ {\sum }_{k = 1}^{{N}_{s}} {( {y}_{k} - {w}^{T} φ ( x ) - b )}^{2} \qquad ( 14 )$$

$$minimize J ( w , e ) = \frac{1}{2} {w}^{T} w + \frac{1}{2} γ {\sum }_{k = 1}^{{N}_{s}} {e}_{k}^{2} \qquad ( 15 )$$

$${e}_{k} = {y}_{k} - {w}^{T} φ ( x ) - b \qquad ( 16 )$$

where γ is the regularization factor used to balance the complexity of the model and data mismatch term; Nₛ is the number of training points.

In some embodiments, the LS-SVR proxy may solve the optimization problem by defining a Lagrangian L with a Lagrangian multiplier αₖ based on Equation 17. Based on Karush-Kuhn-Tucker (KKT) condition, the solution of the LS-SVR proxy may be determined when the optimality is reached when ∇L=0, which is described in Equation 18. Equation 18 may be rearranged in Equations 19 and 20 to eliminate w and e. In particular, Ω is an Nₛ by Nₛ matrix which satisfies Equation 20. Thus, Ω may replace φ(xₖ)^{T}φ(xₗ) in Equation 20 by a kernel function K(xₖ, xₗ) which satisfies Mercer's condition. For example, a radial-basis-function (RBF) is used in the format based on Equation 21. Thus, Equation 13 may be described as Equation 23 by substituting Equation 22 into Equation 13. In SVR-DGN, the primary goal is to estimate ∇ŷ(x), which is given by Equation 24. Equation 23 indicates that α and b are the model parameters of LS-SVR. From Equation 18, a and b may be determined based on Equations 25 and 26.

$$L ( w , b , e ; α ) = J ( w , e ) - {\sum }_{k = 1}^{{N}_{s}} {α}_{k} ( {w}^{T} φ ( {x}_{k} ) + b + {e}_{k} - {y}_{k} ) \qquad ( 17 )$$

$$\{ \begin{matrix}{∇}_{w} L = 0 \to w = {\sum }_{k = 1}^{{N}_{s}} {α}_{k} φ ( {x}_{k} ) \\ \frac{\partial L}{\partial b} = 0 \to {\sum }_{k = 1}^{{N}_{s}} {α}_{k} = 0 , \\ {∇}_{e} L = 0 \to α = γ e , \\ \frac{\partial L}{\partial {α}_{k}} = 0 \to {w}^{T} φ ( {x}_{k} ) + b + {e}_{k} - {y}_{k} = 0\end{matrix} \qquad ( 18 )$$

$$[ \begin{matrix}0 & {1}_{{N}_{s}}^{T} \\ {1}_{{N}_{s}} & Ω + \frac{1}{γ} I\end{matrix} ] [ \begin{matrix}b \\ α\end{matrix} ] = [ \begin{matrix}0 \\ y\end{matrix} ] \qquad ( 19 )$$

$$Ω ( {x}_{k} , {x}_{l} ) = {φ ( {x}_{k} )}^{T} φ ( {x}_{l} ) \qquad ( 20 )$$

$$K ( {x}_{k} , {x}_{l} ) = exp ( \frac{{‖ {x}_{k} - {x}_{l} ‖}^{2}}{{σ}^{2}} ) \qquad ( 21 )$$

$$w = {\sum }_{k = 1}^{{N}_{s}} {α}_{k} φ ( {x}_{k} ) \qquad ( 22 )$$

$$y ( x ) = {\sum }_{k = 1}^{{N}_{s}} {α}_{k} {φ ( {x}_{k} )}^{T} φ ( x ) + b = {\sum }_{k = 1}^{{N}_{s}} {α}_{k} K ( {x}_{k} , x ) + b \qquad ( 23 )$$

$$∇ y ( x ) = {\sum }_{k = 1}^{{N}_{s}} \frac{2 {α}_{k}}{σ} K ( {x}_{k} , x ) ( {x}_{k} - x ) \qquad ( 24 )$$

$$b = \frac{{1}_{{N}_{s}}^{T} {( Ω + \frac{1}{γ} I )}^{- 1} y}{{1}_{{N}_{s}}^{T} {( Ω + \frac{1}{γ} I )}^{- 1} {1}_{{N}_{s}}} \qquad ( 25 )$$

$$α = {( Ω + \frac{1}{γ} I )}^{- 1} y - b {( Ω + \frac{1}{γ} I )}^{- 1} {1}_{{N}_{s}} \qquad ( 26 )$$

where yₖ is proxy output; φ(x) is the input of the proxy in the feature space; w^{T} is the slope of the linear equation in the feature space; and b is the yₖ intercept of the linear equation in the feature space, e is data mismatch in the feature space; αₖ is the Lagrangian multiplier; y is the regularization factor; Nₛ is the number of training points; I is an identity matrix with a dimension of Nₛ; 1_{N}_{ₛ}=[1, 1, . . . , 1]^{T}∈ [symbol] _{N}_{ₛ}; y=y₁, y₂, . . . , y_{N}_{_{S}}]^{T} is a column vector containing all the training output variables, and Ω is Nₛ by Nₛ matrix.

In some embodiments, the LS-SVR may be extended in a multi-dimensional space. If the target response is in the multi-dimension space, such as the production rate of multiple wells across different dates, the LS-SVR may replace y in Equations 25 and 26 by corresponding training output data and recompute b and a. For a history-matching problem, the output response generally is in a high dimension, so recomputing b and a one-by-one for each response incurs heavy computational cost. However, in Equation 25 and 26, the major computations lie in the term

$${( Ω + \frac{1}{γ} I )}^{- 1} ,$$

which is independent of the training output y. Therefore, the LS-SVR may compute

$${( Ω + \frac{1}{γ} I )}^{- 1}$$

once and store the results for later use to save computational time in training multi-response proxies. Specifically, in the multi-response LS-SVR, the responses in a vector are predicted based on modifying Equation 23 and given by Equation 27. The sensitivity matrix Ĝ(x) may be defined based on Equation 28. Thus, A and B may be computed based on Equations 29 and 30. Equations 28-30 represent a tight form of LS-SVR for multi-response prediction. By computing

$${( Ω + \frac{1}{γ} I )}^{- 1}$$

once and reusing in Equations 29 and 30, the multi-response LS-SVR may reduce the trading cost significantly compared to simply retraining in tradition. Note that as

$$Ω + \frac{1}{γ} I$$

is a positive-definite matrix, its inverse matrix always exists and is unique. Among multiple methods for inverting

$$Ω + \frac{1}{γ} I ,$$

the multi-response LS-SVR may choose Cholesky decomposition to perform the task.

$$\hat{y} ( x ) = {\sum }_{k = 1}^{{N}_{s}} {A}_{k} K ( {x}_{k} , x ) + B \qquad ( 27 )$$

$$\hat{G} ( x ) = {( ∇ {\hat{y} ( x )}^{T} )}^{T} = {\sum }_{k = 1}^{{N}_{s}} \frac{2 {A}_{k}}{σ} K ( {x}_{k} , x ) {( {x}_{k} - x )}^{T} \qquad ( 28 )$$

$$B = {( \frac{{1}_{{N}_{s}}^{T} {( Ω + \frac{1}{γ} I )}^{- 1} {y}_{t}}{{1}_{{N}_{s}}^{T} {( Ω + \frac{1}{γ} I )}^{- 1} {1}_{{N}_{s}}} )}^{T} \qquad ( 29 )$$

$$A = {( Ω + \frac{1}{γ} I )}^{- 1} {y}_{t} - {( Ω + \frac{1}{γ} I )}^{- 1} {1}_{{N}_{s}} {B}^{T} \qquad ( 30 )$$

where ŷ(x)=[ŷ⁽¹⁾(x), ŷ⁽²⁾(x), . . . , ŷ^{(N}^{_{d}}⁾(x)]^{T}∈ [symbol] _{N}_{_{d}}_{×1}, with N_{d} being the dimension of output response; Aₖ=[αₖ⁽¹⁾, αₖ⁽²⁾, . . . , αₖ^{N}^{_{d}}]^{T}∈ [symbol] _{N}_{_{d}}_{×1} and B=[b₁, b₂, . . . , b_{N}_{_{d}}]^{T}∈ [symbol] _{N}_{_{d}}_{×1}; the estimated T sensitivity matrix

$$matrix \hat{G} ( x ) ∈ {ℝ}_{{N}_{d \times {N}_{x}}} ;$$

yₜ=

$$[ {[ {y}_{1}^{( 1 )} , {y}_{2}^{( 1 )} , … , {y}_{{N}_{s}}^{( 1 )} ]}^{T} , {[ {y}_{1}^{( 2 )} , {y}_{2}^{( 2 )} , … , {y}_{{N}_{s}}^{( 2 )} ]}^{T} , … , {[ {y}_{1}^{( {N}_{d} )} , {y}_{2}^{( {N}_{d} )} , … , {y}_{{N}_{s}}^{( {N}_{d} )} ]}^{T} ] ∈ {ℝ}_{{N}_{s}} \times {N}_{d} ,$$

which contains all the training outputs of different responses; matrix A is defined by

$${[ {A}_{1} , {A}_{2} , … , {A}_{{N}_{s}} ]}^{T} ∈ {ℝ}_{{N}_{s}} \times {N}_{d} .$$

### Sparsity-Constrained History Matching

In some embodiments, the RGNet may apply a sparsity-constrained history-matching approach to simultaneously determine the well connection pattern, reservoir connectivity, and other related model parameters. Because all wells are connected to each other in RGNet, some issues may occur when applying RGNet to a large-scale petroleum reservoir system with a large number of wells. For example, RGNet may be difficult to tune a large number of parameters. As another example, it is hard to explain physically if two distant wells are connected for a large reservoir. Traditional methods solve these issues by defining the connections based on the distance-based criteria. For example, the traditional methods may use a max-min distance, which requires defining a threshold distance, and any well pair below that distance will be connected. As another example, the traditional methods may use Delaunay triangulation, which connects the wells using triangles. As another example, the traditional method may use a connection map provided by a user based on prior experience. Once the well connection is fixed, the connectivity Tₓ is determined through history matching. Though traditional algorithms mentioned work well in most cases, it may not be adequate in certain circumstances. The main reason is that the effects of dynamic production history are not considered. If the connections are predetermined, other connection pathways will be ignored, which may generate suboptimal solutions. Thus, a sparsity-constrained history-matching algorithm is developed to decide the well connections and match the data together. The sparsity-constrained history matching algorithm may include an objective function for history matching based on Equation 31. Because Tₓ≥0 always holds, the objective function in Equation 31 may be rewritten in Equation 32. Thus, the sparsity-constrained history matching may apply SVR-DGN to solve Equation 32 as minimizing Equation 32 is not significantly different than minimizing Equation 6.

$$O ( x ) = \frac{1}{2} {( y ( x ) - {y}_{obs} )}^{T} {C}_{d}^{- 1} ( y ( x ) - {y}_{obs} ) + \frac{1}{2} λ {‖ {T}_{x} ‖}_{1} \qquad ( 31 )$$

$$O ( x ) = \frac{1}{2} {( y ( x ) - {y}_{obs} )}^{T} {C}_{d}^{- 1} ( y ( x ) - {y}_{obs} ) + \frac{1}{2} λ {\sum }_{i = 1}^{N} {T}_{x , i} \qquad ( 32 )$$

where ½λ∥Tₓ∥₁ is the sparsity-regularization term for inter-well transmissibility; and ∥⋅∥₁ represents l₁-norm to enforce the sparsity.
Enhanced RGNet with PIML

In some embodiments, the RGNet may be enhanced by applying a PIML algorithm to correct history matching errors which cause a discrepancy between a model response using RGNet and corresponding historical data. In some embodiments, the discrepancy may be due to some minor physics which is not included as part of a reservoir simulation model. In particular, the enhanced RGNet with PIML may collect history matching errors as training data and determine an ML model to correct the collected history matching errors.

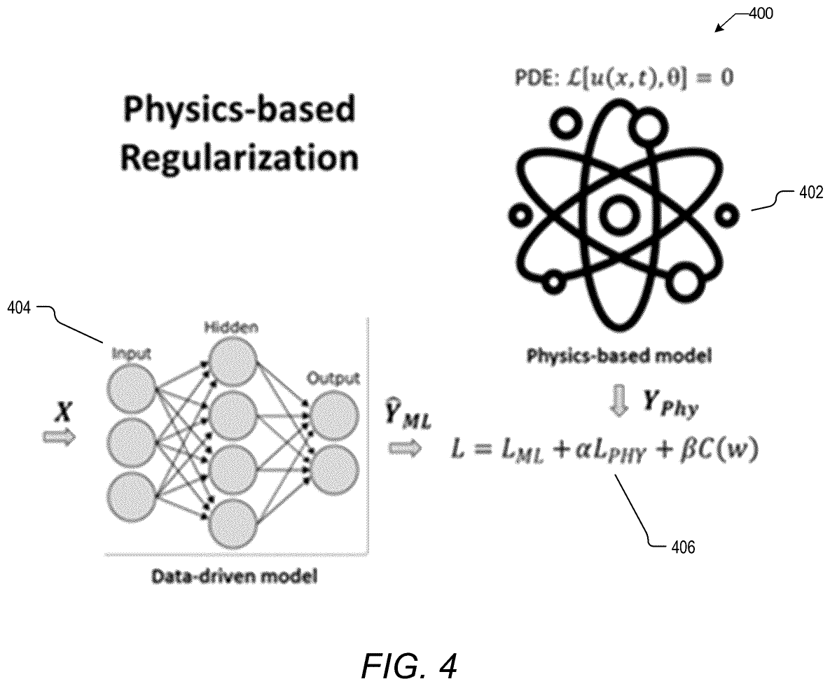

FIG. 4 illustrates an example PIML architecture 400, in accordance with certain embodiments. The PIML architecture 400 is implemented after history matching is complete. The PIML architecture 400 may use history matching errors as training data to determine an ML model 404 based on a physics model 402. Thus, the enhanced RGNet with PIML may include an objective function with a physics-based regularization term 406. The enhanced RGNet with PIML may be implemented in two steps: 1) the enhanced RGNet with PIML may run an RGNet model during a forecast period to obtain the target responses yₖ, k=1, 2, . . . , n_{Forecast}; 2) the enhanced RGNet with PIML may determine an ML model to correct a plurality of history matching errors during the forecast period. In particular, after history-matching is done, the best-matched realization in terms of the lowest matching error is selected as the base model for further correction. The enhanced RGNet may choose a training dataset by selecting a plurality of history matching errors between simulated data y and observed data y_{obs} from a historical period. The enhanced RGNet may include a loss function based on Equation 33. The enhanced RGNet with PIML has a goal to determine an ML model f(⋅) by minimizing L(θ) in order to correct a target variable y during the historical period based on Equation 34. As a result, the enhanced RGNet with PIML may also use the ML model to correct history matching errors for the RGNet model during the forecast period.

$$L ( θ ) = {\sum }_{i} {( f ( θ , {y}_{i} , {γ}_{i} ) - \frac{{y}_{obs , i}}{{y}_{i}} )}^{2} \qquad ( 33 )$$

$${y}_{k} = {y}_{k} \cdot f ( θ , {y}_{k} , {γ}_{k} ) \qquad ( 34 )$$

where y_{obs,i} is the observed data; yᵢ is the simulated data at a given time i; i=1, 2, . . . , n_{Hist} represents the index of data point for the historical period; f(⋅) is the ML model; θ is the vector of coefficients, which will be determined after training; and y represents additional input parameters.

In some embodiments, ML model 404 may be determined using a random-forest (RF) algorithm and a grid-search with cross-validation to find the best combination of hyper-parameters (estimator number and max forest depth). In particular, ML model 404 may be trained using a random forest algorithm to determine a random forest model consisting of multiple decision trees. A decision tree model is a block of a random forest model, and multiple decision tree models are combined to make a random forest model. For example, each individual tree in the random forest model splits out a class prediction, and the class with the most votes becomes our model's winning prediction. Compared to a decision tree algorithm, a random forest tree uses a large number of relatively uncorrelated decision tree models to operate as a committee to determine a winner class which usually outperforms any of the individual constituent decision tree models. In other embodiments, one or more other ML models may be used, including, but not limited to an artificial neural network, random forest, gradient boosting, support vector machine, a kernel density estimator, and combinations thereof.

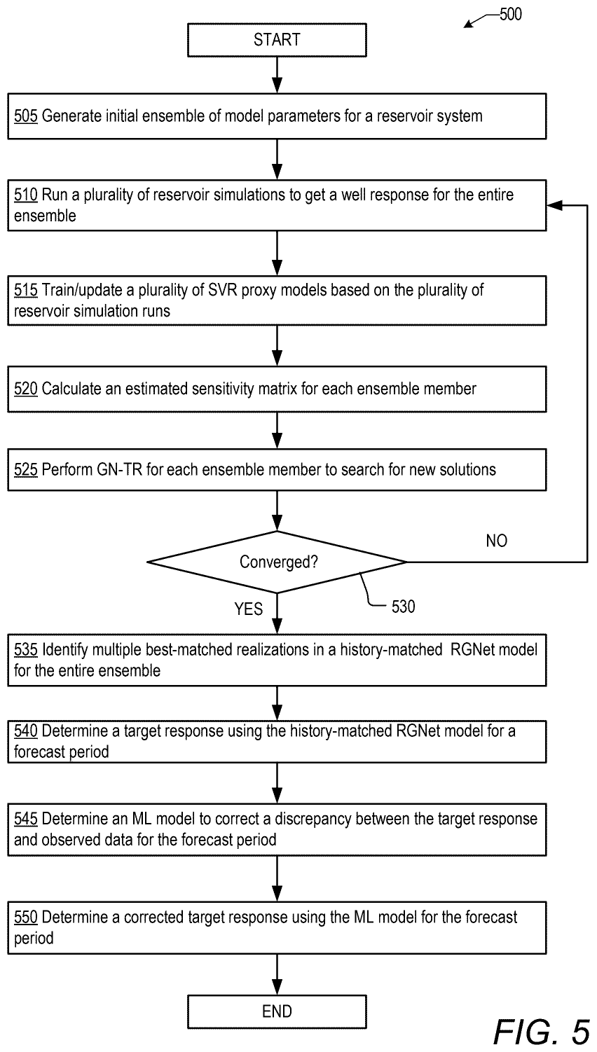

FIG. 5 illustrates an example method 500 for performing an enhanced RGNet with PIML for history matching with SVR-DGN for a reservoir system. Method 500 of FIG. 5 may be used by system 150 of FIG. 1B. Method 500 starts at step 505, where the enhanced RGNet with PIML may generate initial ensemble of model parameters for the reservoir system. In particular, the initial ensemble of model parameters may include a plurality of model parameters x=[x₁, x₂, . . . , xₙ].

At step 510, the enhanced RGNet with PIML may run a plurality of reservoir simulations to get a response y(x) for the entire ensemble. For example, the response y(x) may be one or more types of observed data, such as BHP, GOR, and WCT.

At step 515, the enhanced RGNet with PIML may train and/or update a plurality of SVR proxy models based on the plurality of reservoir simulation runs. In an embodiment, the plurality of proxy models may be least-square SVR with closed-form formulations so that their derivatives may be analytically obtained.

At step 520, the enhanced RGNet with PIML may calculate an estimated sensitivity matrix for each ensemble member. In particular, the enhanced RGNet with PIML may differentiate the SVR models directly to obtain the estimated sensitivity matrix.

At step 525, the enhanced RGNet with PIML may perform GN-TR for each ensemble member to search for new solutions. In an embodiment, enhanced RGNet with PIML may apply GN-TR to determine a new solution x*ᵢ for a corresponding ensemble member by minimizing an objective function of the history matching which includes a Gauss-Newton Hessian.

At step 530, the enhanced RGNet with PIML may make a determination of whether all realizations are converged for the ensemble. In an embodiment, for each ensemble member, the enhanced RGNet with PIML may stop updating the corresponding ensemble member when the new solution is within a trust-region radius from the starting point for optimization. For example, the enhanced RGNet with PIML may stop updating xᵢ when a new solution x*ᵢ is within a trust-region radius Δₘᵢₙ from the starting point for optimization: ∥x*ᵢ−xᵢ∥<Δₘᵢₙ. Where the realizations are converged for all ensemble members, the process may proceed to step 535. Where the realizations are not converged for an ensemble member, the process may proceed to step 510 for the non-converged realization.

At step 535, the enhanced RGNet with PIML may identify multiple best-matched realizations in a history-matched RGNet model for the entire ensemble.

At step 540, the enhanced RGNet with PIML may determine a target response using the history-matched RGNet model for a forecast period. For example, the target response may be one or more types of observed data, such as BHP, GOR, and WCT. In an embodiment, the enhanced RGNet with PIML may select the best-matched realization in terms of the lowest matching error as the base model for further correction.

At step 545, the enhanced RGNet with PIML may determine an ML model to correct a discrepancy between the target response and observed data for the forecast period. The enhanced RGNet may choose a training dataset by selecting a plurality of history matching errors between simulated data y and observed data y_{obs} from a historical period. The enhanced RGNet with PIML may determine the ML model in order to correct a target variable y during the forecasting period.

At step 550, the enhanced RGNet with PIML may use the ML model to determine a corrected target response for the forecasting period.

Particular embodiments may repeat one or more steps of the method of FIG. 5, where appropriate. Although this disclosure describes and illustrates particular steps of the method of FIG. 5 as occurring in a particular order, this disclosure contemplates any suitable steps of the method of FIG. 5 occurring in any suitable order. Moreover, although this disclosure describes and illustrates an example method to perform the enhanced RGNet with PIML for history matching with SVR-DGN for a reservoir system, including the particular steps of the method of FIG. 5, this disclosure contemplates any suitable method including any suitable steps, which may include all, some, or none of the steps of the method of FIG. 5, where appropriate. In some embodiments, although this disclosure describes and illustrates particular components, devices, or systems carrying out particular steps of the method of FIG. 5, this disclosure contemplates any suitable combination of any suitable components, devices, or systems carrying out any suitable steps of the method of FIG. 5.

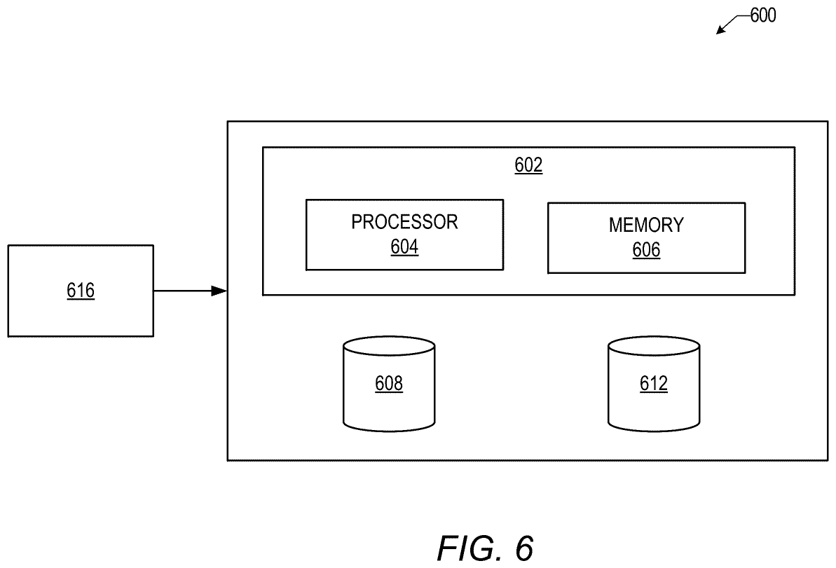

FIG. 6 illustrates a block diagram of an exemplary control unit 600, in accordance with certain embodiments. In certain example embodiments, control unit 600 may be configured to create and maintain a first database 608 that includes information concerning one or more fluid systems. In other embodiments the control unit 600 is configured to create and maintain databases 608 with information concerning one or more fluid systems. In certain example embodiments, control unit 600 is configured to use information from database 608 to train one or many machine learning algorithms 612, including, but not limited to, artificial neural network, random forest, gradient boosting, support vector machine, or kernel density estimator. In some embodiments, control system 602 may include one more processors, such as processor 604. Processor 604 may include, for example, a microprocessor, microcontroller, digital signal processor (DSP), application specific integrated circuit (ASIC), or any other digital or analog circuitry configured to interpret and/or execute program instructions and/or process data. In some embodiments, processor 604 may be communicatively coupled to memory 606. Processor 604 may be configured to interpret and/or execute non-transitory program instructions and/or data stored in memory 606. Program instructions or data may constitute portions of software for carrying out fluid system modeling, as described herein. Memory 606 may include any system, device, or apparatus configured to hold and/or house one or more memory modules; for example, memory 606 may include read-only memory, random access memory, solid state memory, or disk-based memory. Each memory module may include any system, device, or apparatus configured to retain program instructions and/or data for a period of time (e.g., computer-readable non-transitory media).

Although control unit 600 is illustrated as including two databases, control unit 600 may contain any suitable number of databases and machine learning algorithms. Control unit 600 may be communicatively coupled to one or more displays 616 such that information processed by sensor control system 602 may be conveyed to operators at or near the pipeline or flowline or may be displayed at a location offsite.

Modifications, additions, or omissions may be made to FIG. 6 without departing from the scope of the present disclosure. For example, FIG. 6 shows a particular configuration of components for control unit 600. However, any suitable configurations of components may be used. For example, components of control unit 600 may be implemented either as physical or logical components. Furthermore, in some embodiments, functionality associated with components of control unit 600 may be implemented in special purpose circuits or components. In other embodiments, functionality associated with components of control unit 600 may be implemented in a general purpose circuit or components of a general purpose circuit. For example, components of control unit 600 may be implemented by computer program instructions. In particular, the ML-enhanced history matching algorithm with SVR-DGN and sparsity constrained regularization described above may be implemented by computer program instructions.

To facilitate a better understanding of the present disclosure, the following examples of certain aspects of preferred embodiments are given. The following examples are not the only examples that could be given according to the present disclosure and are not intended to limit the scope of the disclosure or claims.

### Example 1

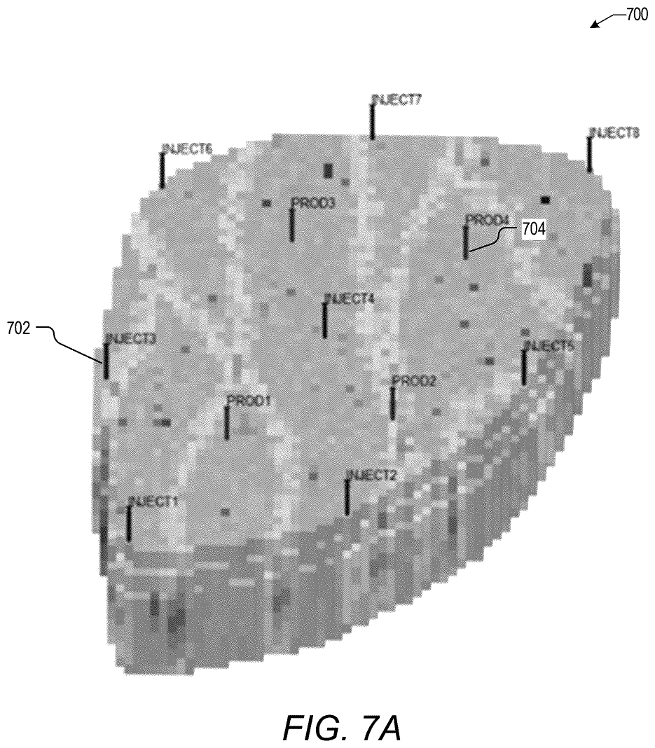

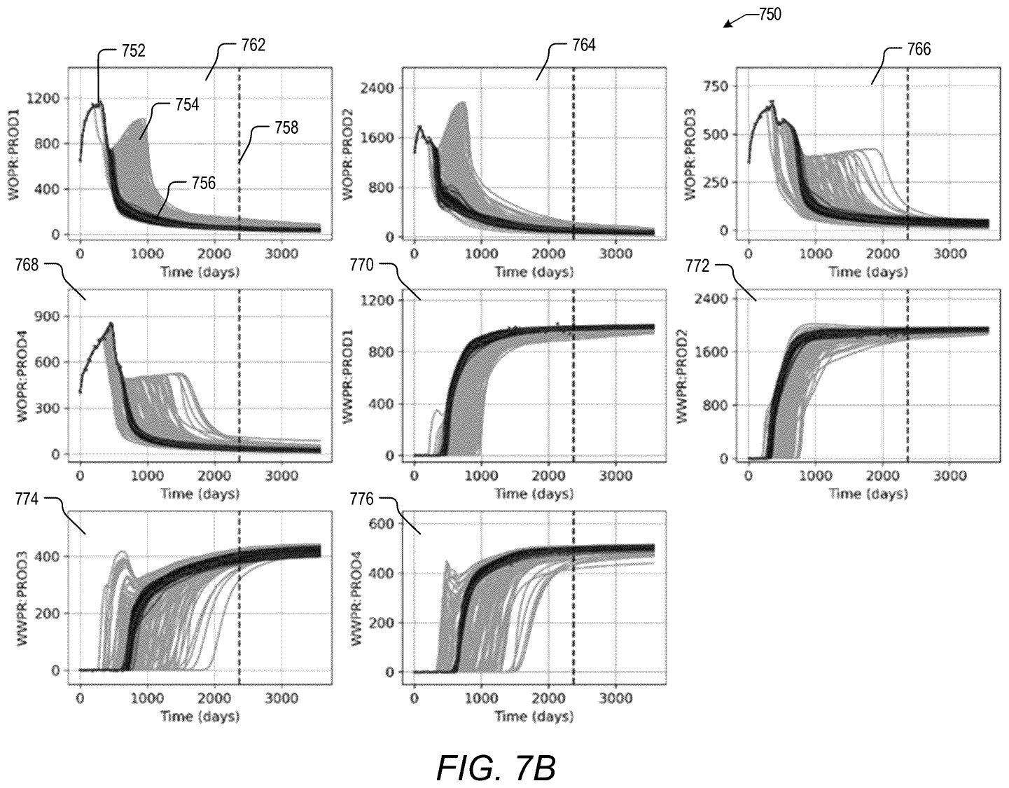

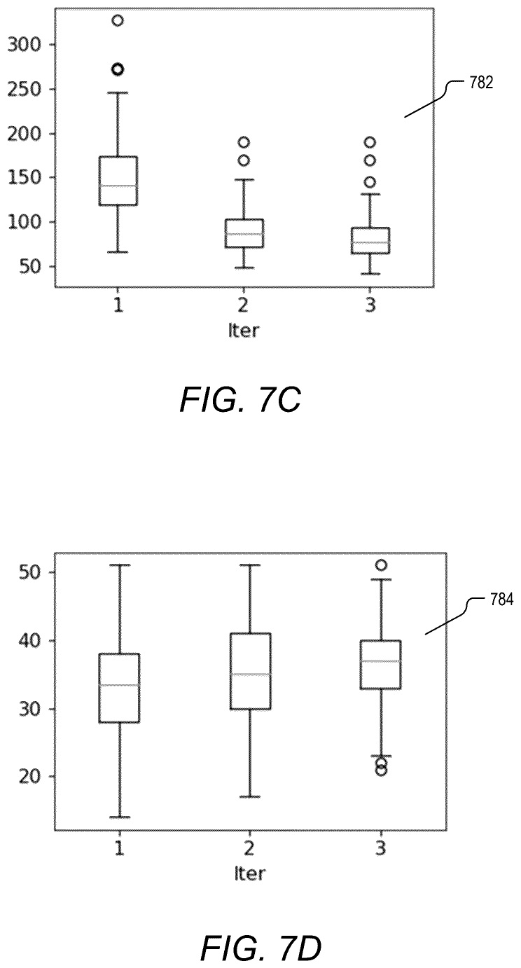

FIG. 7A illustrates an example synthetic egg model 700 of a permeability field, in accordance with certain embodiments. The synthetic egg model 700 may include a synthetic 3D reservoir model of a channelized oil reservoir. In particular, the synthetic egg model 700 is a waterflooded reservoir with 8 water injectors 702 and 4 producers 704. The synthetic egg model 700 may be used as the “true” model to generate the data for history matching.

FIG. 7B illustrates an example history matching result 750 for a plurality of wells in FIG. 7A, in accordance with certain embodiments. An RGNet model is built to model this reservoir using 2 inner cells and 1 outer cell per well as a global setting. One-hundred prior realizations 754 are randomly generated as the prior models for history matching, and all the models start with full connections where all the wells are connected to each other. A sparsity-constrained history-matching using SVR-DGN workflow is applied to determine a history-matched model which provides posterior results 756 for oil production rate (OPR), such as 762, 764, 766, and 768, and WCT, such as 770, 772, 774, and 776, associated with 4 producers, such as PROD1, PROD2, PROD3, and PROD4, associated with the reservoir. In particular, the sparsity-constrained history-matching using SVR-DGN workflow attempts to optimize an objective function for history matching using SVR-DGN with a sparsity-regularization term in order to successfully match the historical data and find a plurality of crucial well connections by keeping a minimum number of active well-pairs.

In some embodiments, the synthetic model 700 (referring to FIG. 7A) may include a permeability field of roughly 10 years of history. The sparsity-constrained history-matching using SVR-DGN workflow may use the first four years of data for history matching and the remaining for predictions. For history-matching, the oil and water rates are treated as the observed data, and injection rate and production liquid are fixed as the well operating constraints. The history-matching parameters include cell pore volumes, intra- and inter-well transmissibilities. Note that the inter-well transmissibility is allowed to take a zero value to disable connection between a well pair, if needed.

In some embodiments, FIG. 7B shows the history-matching results with predictions show all the data 752 are matched with good quality and the predictions are reasonably good for the unseen data that is not used for history matching. In particular, significant differences may be observed in performance for the 4 producers. In particular, PROD1 762 and PROD2 764 show higher oil production rates than PROD3 768 and PROD4 770 at the early stages of production. In some embodiments, a hold-off test with the history-matched model also shows good agreement between blind forecasts and actual data for a blind test period which is separated from the historical matching period by a vertical black line 758.

FIGS. 7C and 7D illustrate example distributions of data mismatch 782 and the number of inactive connections 784 for the reservoir model in FIG. 7A, in accordance with certain embodiments. The data mismatch 782 of history matching converges in 3 iterations. Over the 3 iterations, the data mismatch 782 gradually decreases in FIG. 7C and the number of inactive well connections 784 gradually increase in FIG. 7D. The decrease of the data mismatch 782 and the increase of the number of inactive well connections 784 indicate that a good history match is obtained with much fewer well connections needed.

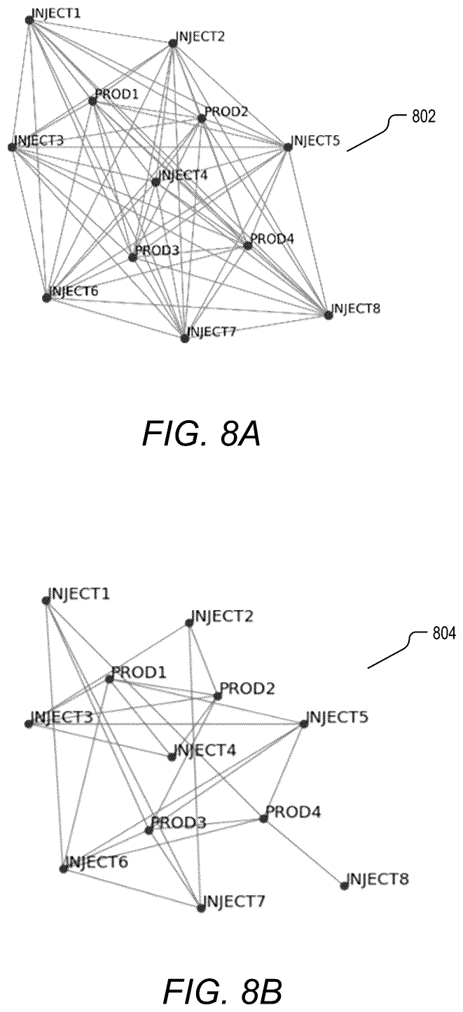

FIG. 8A illustrates an example full connection map 802 for the reservoir model in FIG. 7A, in accordance with certain embodiments. FIG. 8A shows the full-connection set-up map 802 with a connection for each of a plurality of well pairs. FIG. 8B illustrates an example single realization of sparsity-constrained well connections map 804 for the reservoir model in FIG. 7A, in accordance with certain embodiments. The history-matched well connections in the single realization of sparsity-constrained well connections map 804 have much less redundancy compared to the full-connections in the full connection map 802 and provide more information to characterize the reservoir connectivity for the reservoir model.

### Example 2

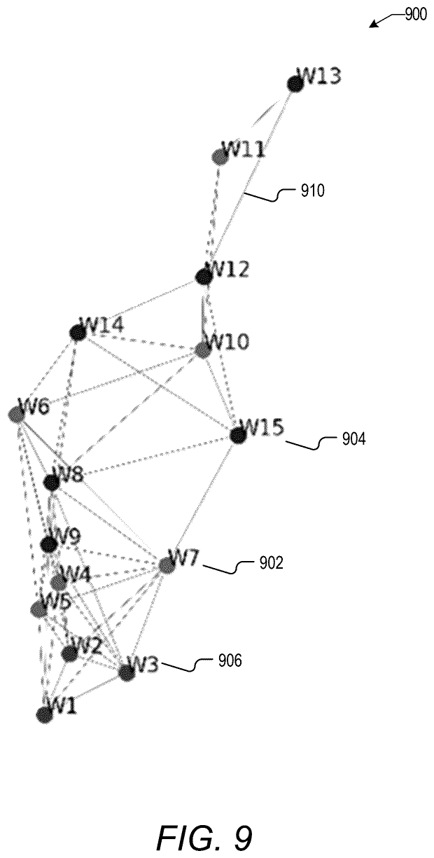

FIG. 9 illustrates an example connection map 900 from operator knowledge for a real reservoir system, in accordance with certain embodiments. The real reservoir system includes a real dataset associated with a greenfield deep-water asset during an early stage of production. The real reservoir system includes six producers 902, six water injectors 904, and three gas injectors 906. The well pairs linked with solid lines 910 are considered “active” connections, and the remaining well pairs without links are considered “inactive” with no communication. These connection patterns are decided and fixed based on knowledge from the operator. The key objectives are to examine the applicability of RGNet to history match, understand reservoir connectivity, and forecast under uncertainty. In particular, a history matching with SVR-DGN is firstly performed on the real dataset to determine a history-matched RGNet model for the real reservoir system. Thus, the history-matched RGNet model may be used to forecast against the real dataset to verify accuracy of the RGNet model.

In some embodiments, the history-matched RGNet model may be enhanced by determining a PIML to correct history matching errors associated with the history-matched RGNet model. The history-matched RGNet model may be further improved for better accuracy in forecasting BHP and water product rate by using a PIML to correct history matching errors associated with the history-matched RGNet model. In this example, the mobile water in the history-matched RGNet model is intentionally removed. In this example, the best-matched realization from the previous section is used as the base model for further improvement with PIML. One or more ML models are trained for a plurality of producers 902 (referring to FIG. 9). For BHP and water-rate corrections, the training inputs are kept the same, including the observed oil/gas/water production rate, cumulative oil production, and BHP data for the corresponding producer. The output target is the ratio of the actual BHP over simulated BHP for BHP correction; for water-rate correction, the target is the ratio of actual water rate over the simulated water rate. The one or more ML models are determined using a random-forest (RF) algorithm and a grid-search with cross-validation to find the best combination of hyper-parameters (estimator number and max forest depth). Then, the one or more ML models are trained with the optimal set of hyper-parameters. Once the one or more ML models are obtained, the RGNet results are corrected by multiplying those ratios predicted by the ML models.

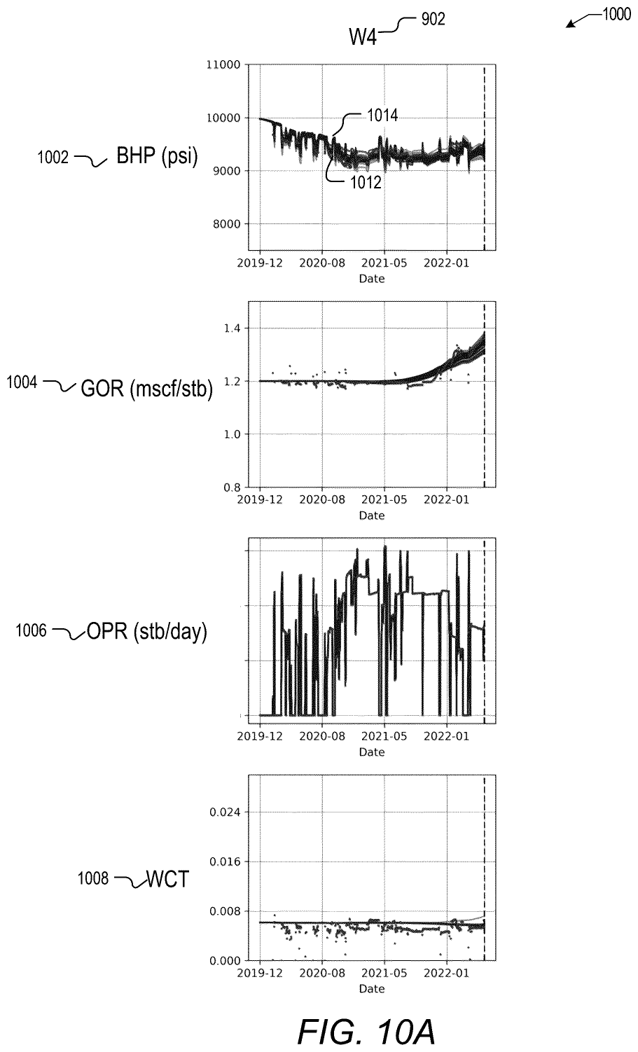

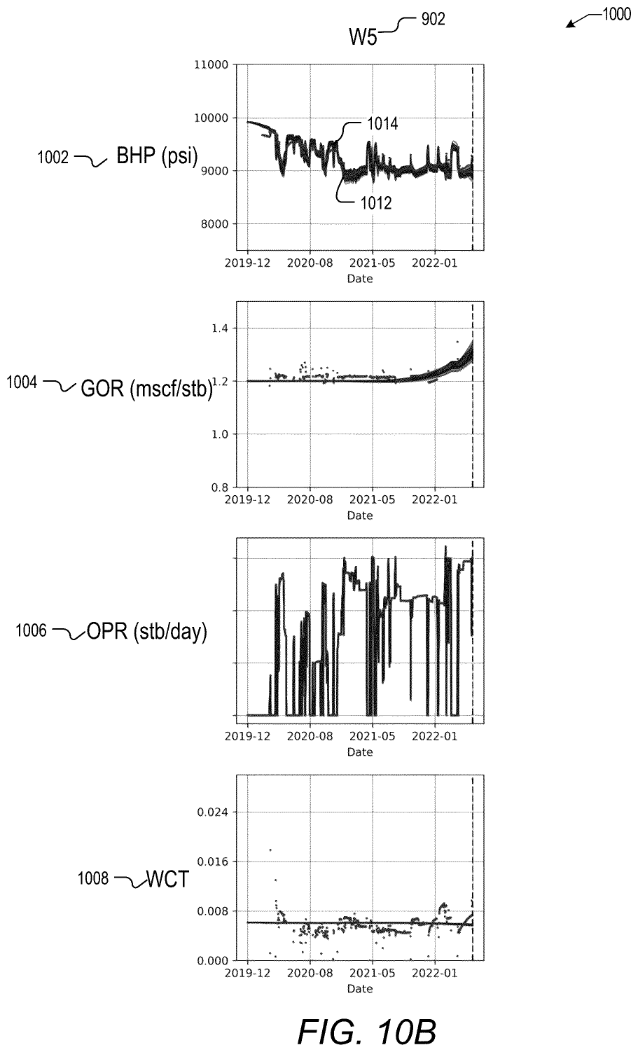

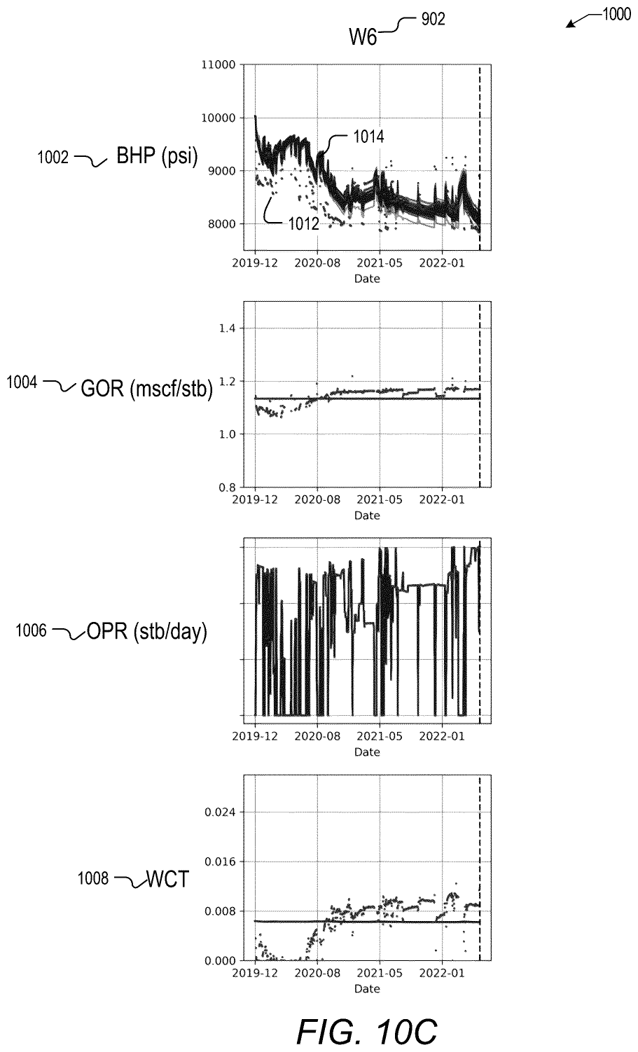

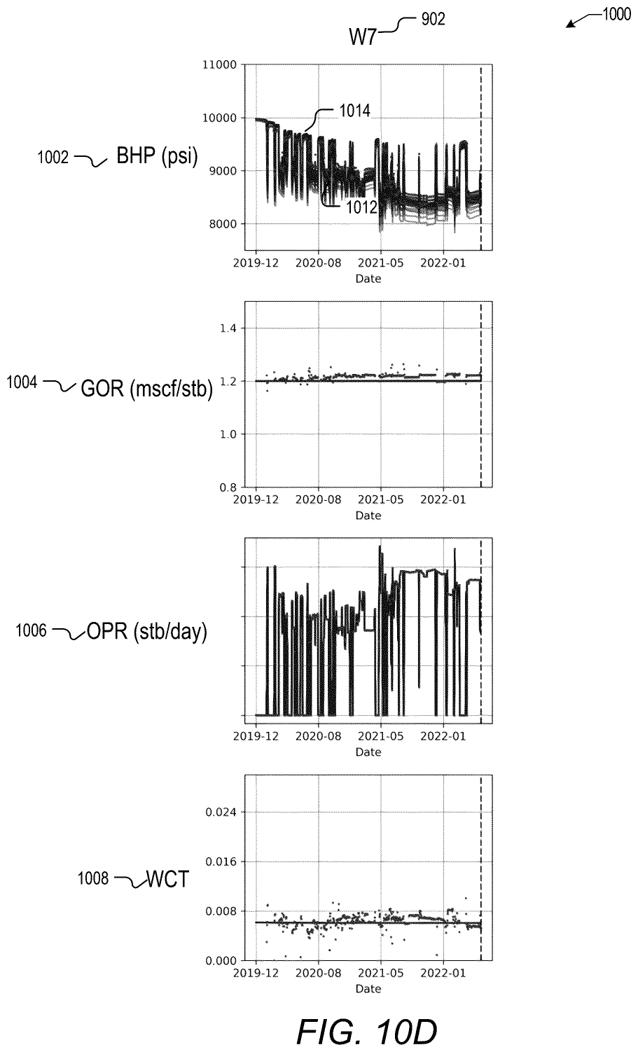

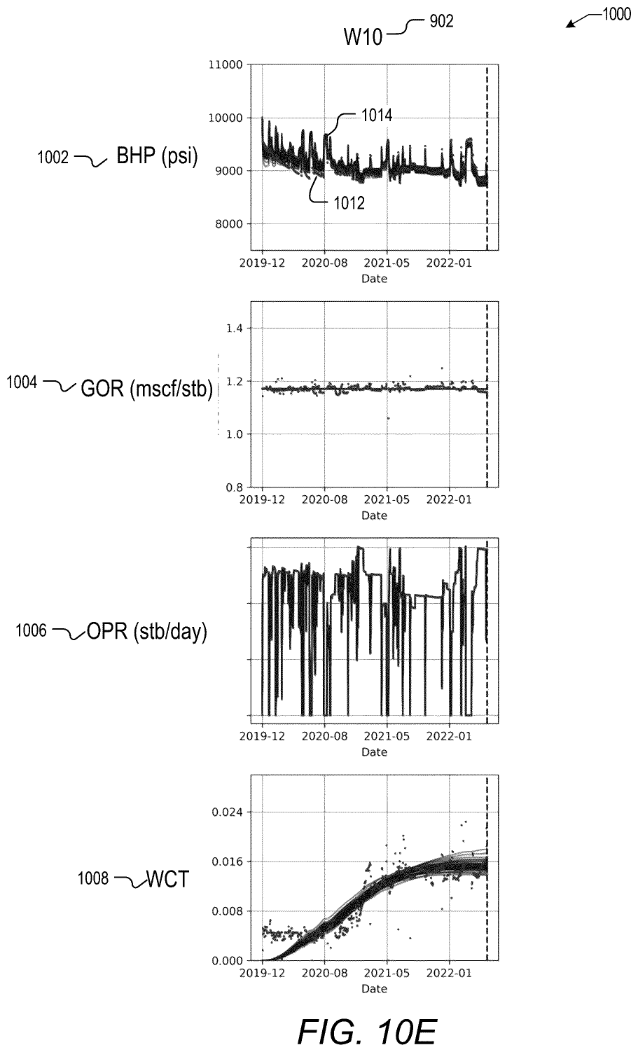

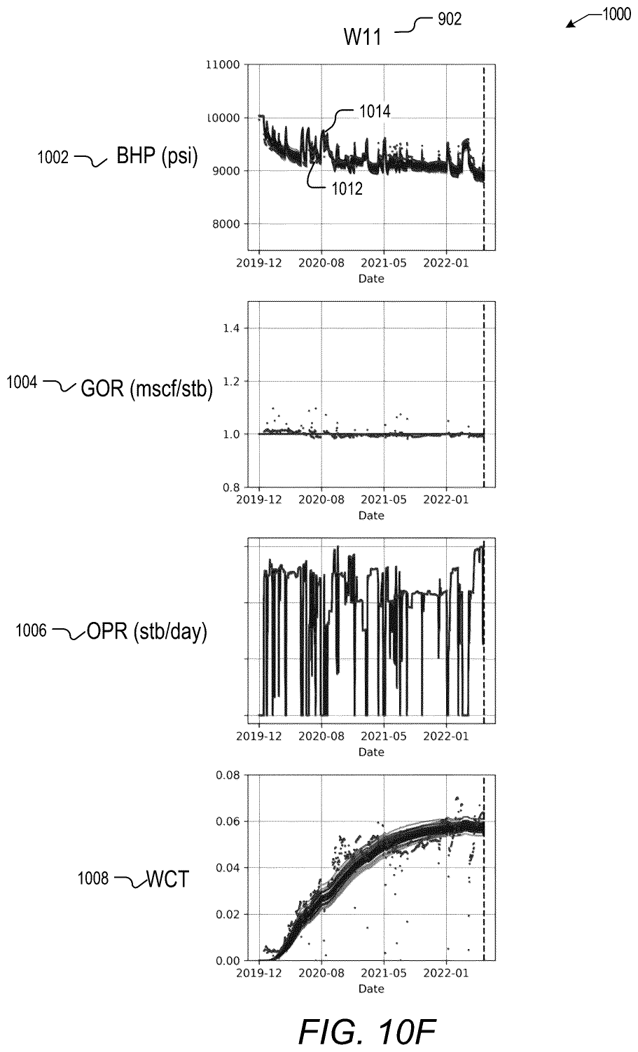

FIGS. 10A-10F illustrate example history matching results 1000 for a plurality of wells associated with the real reservoir system in FIG. 9, in accordance with certain embodiments. To model the real reservoir system, two inner cells and one outer cell are used in RGNet. Also, in this example, some mobile water is incorporated inside the history-matched RGNet model to model the early-stage water production attributed to perched water, up-dip of the aquifer. As part of history-matching settings, OPR and water/gas injection rate are set as well-operating constraints. Producer BHP, WCT, and GOR are set as observed data for matching. About 100 prior realizations are randomly generated to initialize the history-matching ensemble.

In some embodiments, FIGS. 10A-10F show the history matching posterior results 1014 and observed data 1012, such as BHP 1002, GOR 1004, OPR 1006, and water-cut 1008, for six producers 902, such as W4, W5, W6, W7, W10, and W11. In particular, the posterior results 1014 obtained from history-matched realizations with SVR-DGN in FIGS. 10A-10F show there is a good history match between the observed data 1012 and the posterior results 1014. In terms of BHP 1002 matches, the posterior results are in good agreement with the data including those from shut-in periods. W6 shows a relatively large discrepancy, possibly due to a data-quality issue. Although W4 and W5 show gas breakthroughs at the end of the history-matching period with increasing trends of GOR 1004, the history-matched results reasonably capture that. OPR 1006 and the well constraints are exactly matched. As for WCT 1008, W10 and W11 show increasing water-cuts since the inception of production. By adjusting the mobile water size and other related parameters, the water-cut trends of the two wells are honored with good quality.

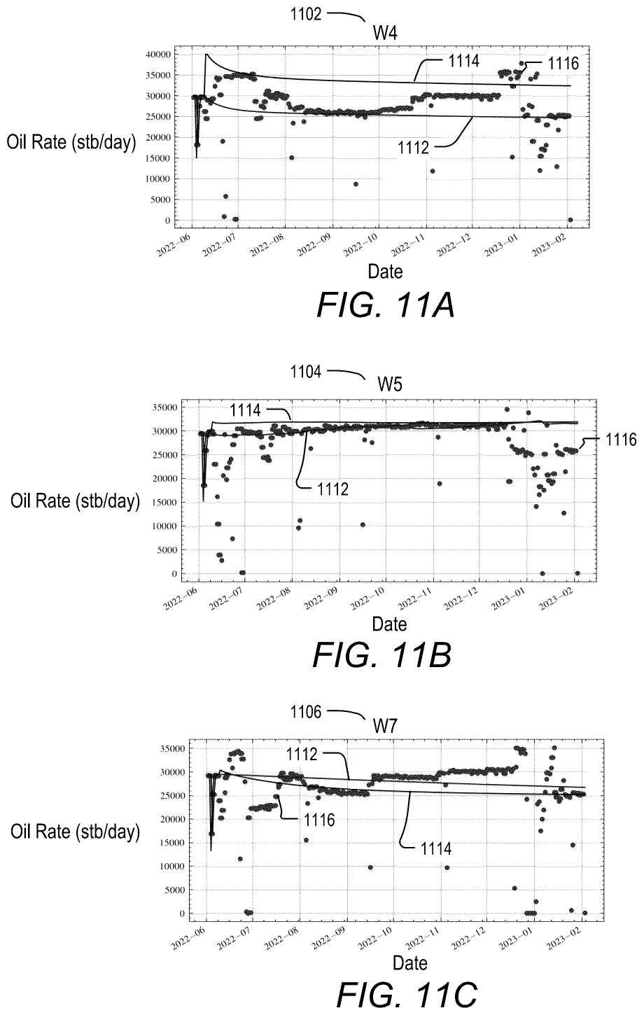

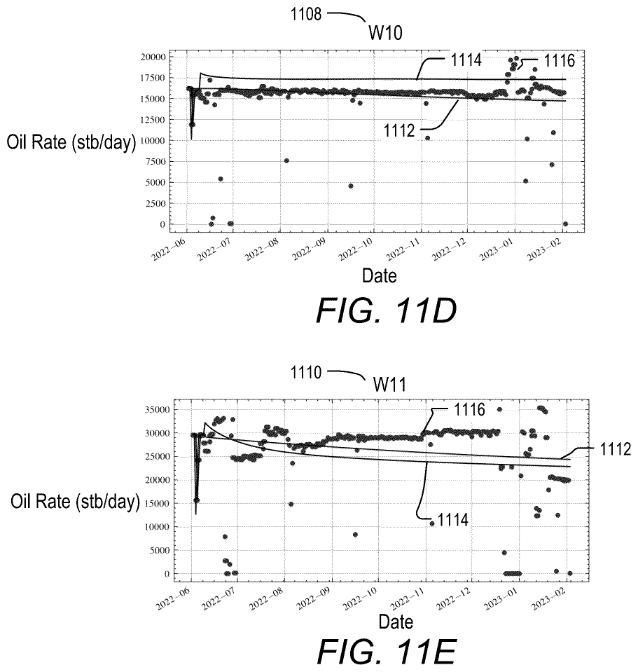

FIGS. 11A-11E illustrate example forecast result for the plurality of wells associated with the real reservoir system in FIG. 9, in accordance with certain embodiments. The history-matched RGNet model may be used to determine forecast results 1112 which are compared against the real dataset 1116 for five producers, such as W4 1102, W5 1104, W7 1106, W10 1108, and W11 1110, to verify the accuracy of the history-matched RGNet model. In this example, the history matching with SVR-DGN may perform forecasting based on the best-matched RGNet model for eight months following the end of the historical period for blind-test validation. The forecast is done by keeping the same producing BHP and injection rate as the last day of the historical period. As a reference, the forecast results from a manually history-matched full-scale reservoir simulation model 1114 provided by the operator are presented as well. In general, the forecasts are aligned with the actual production data. The difference arises from the constant BHP values used for the forecast that do not exactly match the real data. Compared to the reference model, the RGNet model shows higher accuracy in forecasting in terms of less discrepancy to the real data.

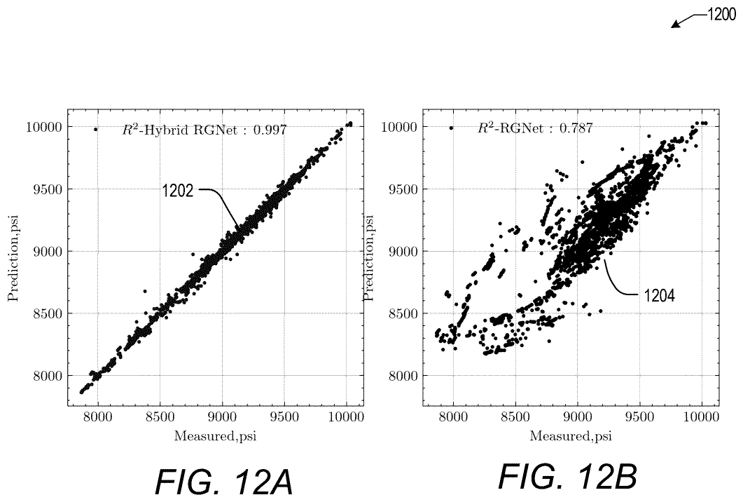

FIGS. 12A and 12B illustrate example cross plots 1200 of bottom-hole pressure (BHP) for corrected and uncorrected RGNet results during the training historical period for the real reservoir system in FIG. 9, in accordance with certain embodiments. FIG. 12A shows the comparison between corrected RGNet results 1202 and actual observed data for historical BHP. FIG. 12B shows the comparison between uncorrected RGNet results 1204 and actual observed data for historical BHP. To assess the model quality, the corrected RGNet results 1202 and uncorrected RGNet results 1204 are compared to the actual observed data in cross plots. A comparison of the corrected RGNet results 1202 and uncorrected RGNet results 1204 indicates that there is a significant improvement in matching BHP after applying the ML-based corrections to the history-matched RGNet model. The quality of the RGNet model may be verified using a sample correlation coefficient R which is a measure of the closeness of association of the points in a scatter plot to a linear regression based on those points. For example, a positive R value indicates a positive association. As another example, a negative R value indicates a negative association. As another example, an R value of zero or near 0 indicates a very weak linear relationship. After applying the ML corrections, the data matching quality is significantly improved, with R² improvement from 78.7% to more than 99.7%.

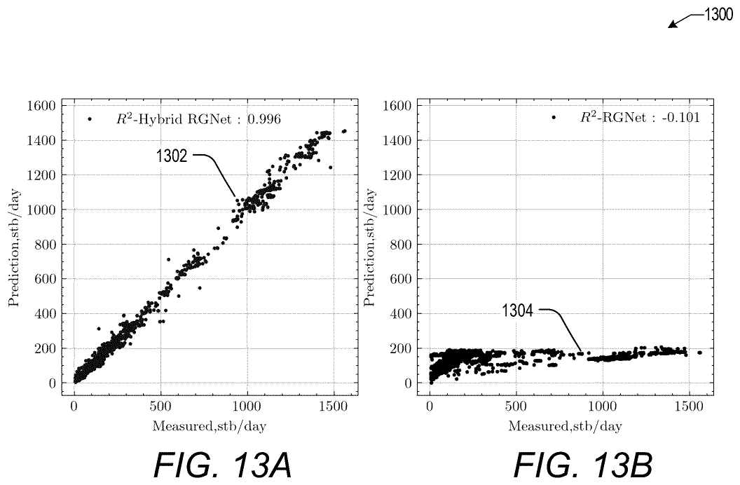

FIGS. 13A and 13B illustrate example cross plots 1300 of water rate for corrected and uncorrected RGNet results during the training historical period for the real reservoir system in FIG. 9, in accordance with certain embodiments. FIG. 13A shows the comparison between corrected RGNet results 1302 and actual observed data for historical water rate. FIG. 13B shows the comparison between uncorrected RGNet results 1204 and actual observed data for historical water rate. To assess the model quality, the corrected RGNet results 1302 and uncorrected RGNet results 1304 are compared to the actual observed data in cross plots. After applying the ML corrections, the data matching quality is significantly improved, with R² improvement from −10.1% to 99.6%.

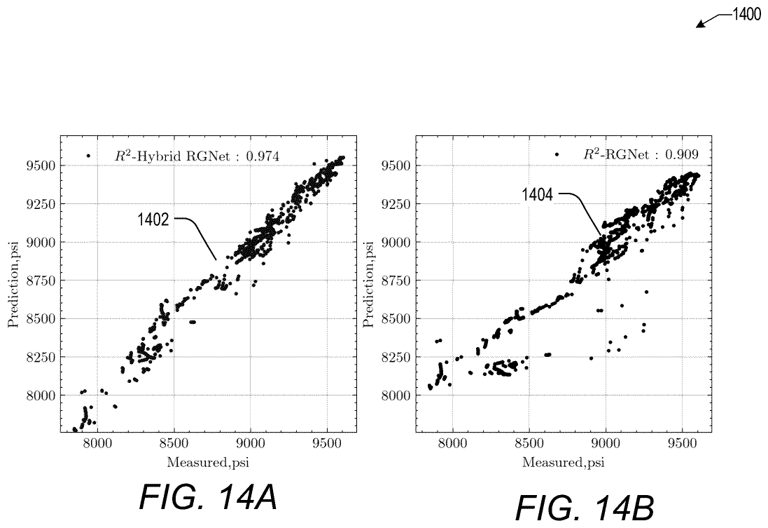

FIGS. 14A and 14B illustrate example cross plots 1400 of BHP for corrected and uncorrected RGNet results during the testing (forecast) period for the real reservoir system in FIG. 9, in accordance with certain embodiments. FIG. 14A shows the comparison between corrected RGNet results 1402 and actual observed data for historical BHP. FIG. 14B shows the comparison between uncorrected RGNet results 1404 and actual observed data for BHP. In particular, the actual observed data are unseen “future” data that is not used for training. To assess the model quality, the corrected RGNet results 1402 and uncorrected RGNet results 1404 are compared to the actual observed data in cross plots. A comparison of the corrected RGNet results 1402 and uncorrected RGNet results 1404 indicates that there is a significant improvement in matching BHP after applying the ML-based corrections to the history-matched RGNet model. After applying the ML corrections, the data matching quality is significantly improved, with R² improvement from 90.9% to more than 97.4%. In general, with ML corrections, the corrected RGNet results 1402 are more consistent with the actual observed data. However, the uncorrected RGNet results 1404 are less consistent with the actual observed data.

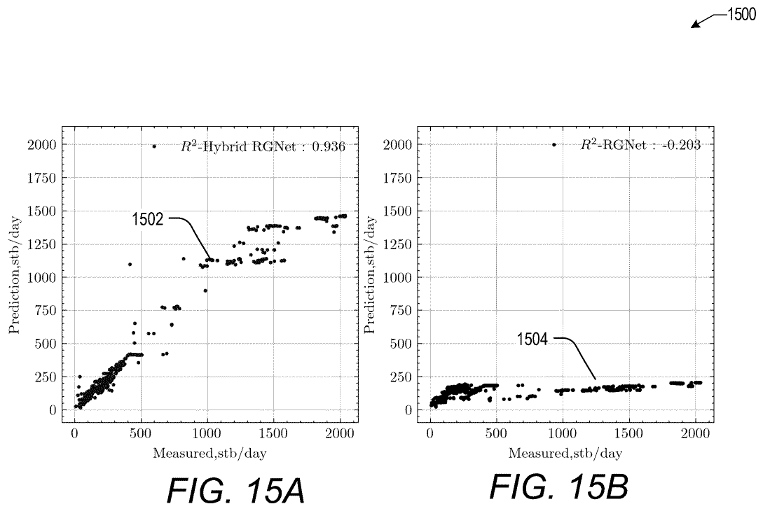

FIGS. 15A and 15B illustrate example cross plots 1500 of water rate for corrected and uncorrected RGNet results during the testing (forecast) period for the real reservoir system in FIG. 9, in accordance with certain embodiments. FIG. 15A shows the comparison between corrected RGNet results 1502 and actual observed data for water rate. FIG. 15B shows the comparison between uncorrected RGNet results 1504 and actual observed data for water rate. In particular, the actual observed data are unseen “future” data that is not used for training. To assess the model quality, the corrected RGNet results 1502 and uncorrected RGNet results 1504 are compared to the actual observed data in cross plots. Because the mobile water is removed, the uncorrected RGNet results 1504 basically fail to match the actual observed data. However, after applying the ML corrections, the data matching quality is significantly improved, with R² improvement from −20.3% to 93.5%. It is also noted that the forecast of water production should be within a proper range with discretion, and long periods of forecast may lead to a larger discrepancy. However, compared to the “raw” RGNet model without mobile water, the ML corrections reasonably capture the missing physics and significantly improve the forecast quality.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the present disclosure. For example, the steps may be combined, modified, or deleted where appropriate, and additional steps may be added. Additionally, the steps may be performed in any suitable order without departing from the scope of the present disclosure.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present disclosure. Also, the terms in the claims have their plain, ordinary meaning unless otherwise explicitly and clearly defined by the patentee. The indefinite articles “a” or “an,” as used in the claims, are each defined herein to mean one or more than one of the element that it introduces.

A number of examples have been described. Nevertheless, it will be understood that various modifications can be made. Accordingly, other implementations are within the scope of the following claims.

What is claimed is:

1. A method of modeling fluid flow dynamics in a reservoir system, comprising:
receiving observed data for the reservoir system;
generating a plurality of model parameters in an initial fluid system model for the reservoir system;
performing a plurality of reservoir simulations to determine a well response for the plurality of model parameters;
identifying a plurality of best-matched realizations by applying history matching to the initial fluid system model;
generating an updated fluid system model based, at least in part, on the plurality of best-matched realizations;
generating a target response using the updated fluid system model for a forecast period;
generating a machine learning (ML) model to correct a discrepancy between the target response and the observed data for the forecast period; and
determining, using the ML model, a corrected target response for the forecast period.

2. The method of claim 1, further comprising:
generating the ML model based on the updated fluid system model for the forecast period.

3. The method of claim 1, further comprising:
determining, using a support-vector-regression with a distributed-Gauss-Newton (SVR-DGN) algorithm, a plurality of support-vector-regression (SVR) proxy models with a closed-form formulation based, at least in part, on the plurality of reservoir simulations;
determining one or more solutions by applying a Gauss-Newton trust-region (GN-TR) approach for each of the plurality of model parameters; and
calculating an estimated sensitivity matrix for each of the plurality of model parameters by differentiating the plurality of SVR proxy models with the closed-form formulation.

4. The method of claim 1, further comprising:
performing closed-loop reservoir management using the corrected target response for the forecast period.

5. The method of claim 1, wherein the observed data for the reservoir system comprises data for at least one metric selected from the group consisting of: oil production rate, water production rate, gas production rate, cumulative oil production, bottom-hole pressure (BHP), gas-oil ratio (GOR), water-cut, and any combination thereof.

6. The method of claim 1, wherein the plurality of model parameters comprise cell pore volumes, intra- and inter-well transmissibilities.

7. The method of claim 3, wherein the SVR-DGN algorithm implements an objective function comprising a sparsity regularization term for inter-well transmissibility.

8. The method of claim 7, wherein the objective function comprises a physics-based regularization term.

9. The method of claim 1, wherein the target response is associated with one or more types of observed data.

10. The method of claim 3, further comprising:
determining well connections for the plurality of SVR proxy models with the closed-form formulation using distance-based criteria and Delaunay triangulation.

11. A system of modeling fluid flow dynamics in a reservoir system, comprising:
one or more processors; and
one or more computer-readable non-transitory storage media comprising instructions that, when executed by the one or more processors, cause one or more components of the system to perform operations comprising:
receiving observed data for the reservoir system;
generating a plurality of model parameters in an initial fluid system model for the reservoir system;
performing a plurality of reservoir simulations to determine a well response for the plurality of model parameters;
identifying a plurality of best-matched realizations by applying history matching to the initial fluid system model;
generating an updated fluid system model based, at least in part, on the plurality of best-matched realizations;
generating a target response using the updated fluid system model for a forecast period;
generating a machine learning (ML) model to correct a discrepancy between the target response and the observed data for the forecast period; and
determining, using the ML model, a corrected target response for the forecast period.

12. The system of claim 11, wherein the operations further comprise:
generating the ML model based on the updated fluid system model for the forecast period.

13. The system of claim 11, wherein the operations further comprise:
determining, using a support-vector-regression with a distributed-Gauss-Newton (SVR-DGN) algorithm, a plurality of support-vector-regression (SVR) proxy models with a closed-form formulation based, at least in part, on the plurality of reservoir simulations;
determining one or more solutions by applying a Gauss-Newton trust-region (GN-TR) approach for each of the plurality of model parameters;
calculating an estimated sensitivity matrix for each of the plurality of model parameters by differentiating the plurality of SVR proxy models with the closed-form formulation.

14. The system of claim 11, wherein the operations further comprise:
performing closed-loop reservoir management using the corrected target response for the forecast period.

15. The system of claim 11, wherein the observed data for the reservoir system comprises data for at least one metric selected from the group consisting of: oil production rate, water production rate, gas production rate, cumulative oil production, bottom-hole pressure (BHP), gas-oil ratio (GOR), water-cut, and any combination thereof.

16. The system of claim 11, wherein the plurality of model parameters comprise cell pore volumes, intra- and inter-well transmissibilities.

17. The system of claim 13, wherein the SVR-DGN algorithm implements an objective function comprising a sparsity regularization term for inter-well transmissibility.

18. The system of claim 17, wherein the objective function comprises a physics-based regularization term.

19. The system of claim 11, wherein the target response is associated with one or more types of observed data.

20. A non-transitory computer-readable medium comprising instructions that are configured, when executed by a processor, to perform operations comprising:
receiving observed data for the reservoir system;
generating a plurality of model parameters in an initial fluid system model for the reservoir system;
performing a plurality of reservoir simulations to determine a well response for the plurality of model parameters;
identifying a plurality of best-matched realizations by applying history matching to the initial fluid system model;
generating an updated fluid system model based, at least in part, on the plurality of best-matched realizations;
generating a target response using the updated fluid system model for a forecast period;
generating a machine learning (ML) model to correct a discrepancy between the target response and the observed data for the forecast period; and
determining, using the ML model, a corrected target response for the forecast period.
